(19) United States
(12) Patent Application Publication
(10) Pub. No.: US 2010/0150635 A1
(43) Pub. Date: Jun. 17, 2010

(54) IMAGE FORMING APPARATUS

(75) Inventors: Toshiaki TANAKA, Toyokawa-shi (JP); Satoshi OGATA, Hachioji-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/637,818

(22) Filed: Dec. 15, 2009

(30) Foreign Application Priority Data
Dec. 16, 2008 (JP) 2008-320010

(51) Int. Cl. G03G 15/00

(52) U.S. Cl. 399/406

(57) ABSTRACT

An image forming apparatus for conducting a fixing process by plural fixing devices for a sheet on which a toner image has been transferred from a transfer section, comprises: a first fixing device arranged on a sheet conveyance passage; a second fixing device arranged on the sheet conveyance passage at a downstream side of the first fixing device; and a curl correcting section arranged on the sheet conveyance passage between the first fixing device and the second fixing device.

This application is based on Japanese Patent Application No. 2008-320010 filed on Dec. 16, 2008, in Japanese Patent Office, the entire content of which is hereby incorporated by reference.

### BACKGROUND OF THE INVENTION

The present invention relates to an image forming apparatus which conducts a fixing process for a sheet of paper (hereafter, referred to merely as a sheet) with plural fixing devices.

Image forming apparatuses with an electro-photographic system, such as a copying machine and a printer, form a toner image on a photoreceptor, and transfer the toner image on a sheet. Then, in a fixing device, the apparatuses apply heat and pressure onto the sheet on which the toner image has been transferred. With such a fixing process by the fixing device, toner is melted, whereby the toner image is fixed onto the sheet.

In order to improve the fixing ability and glossiness of toner, there is a well known technique by which fixing processes are conducted two or more times with two or more fixing devices (for example, refer to Japanese Patent Unexamined Publication No. 2005-309062 and Japanese Patent Unexamined Publication No. 2006-308889). In Japanese Patent Unexamined Publication No. 2005-309062, in order to correct large curl on a sheet caused when the sheet passes through two fixing devices, a curl detecting section to detect the amount of curl and the orientation of curl is provided between two fixing devices and a curl correcting device is provided at the downstream side more than the downstream side fixing device. In such an arrangement, an amount of curl corrected by the curl correcting device is controlled based on the detected amount and orientation of curl.

On the other hand, in Japanese Patent Unexamined Publication No. 2006-308889, a sheet conveying passage branches into to a fixing conveyance passage on which two fixing devices are serially connected and a bypass conveyance passage which bypasses one of the two fixing device, and a curl providing section is provided on each of the bypass conveyance passage and a re-conveyance passage to convey a sheet again to the image forming section. With the above structure, Patent Document 2 has an object that the sheet conveying passage is switched in accordance with the characteristic of a sheet such as thickness and kind and the curl providing section conducts a curl correction efficiently for a sheet conveyed any one of the fixing conveyance passage and the bypass conveyance passage.

In Japanese Patent Unexamined Publication No. 2005-309062, although the curl amount and the like are monitored between two fixing devices, the curl correcting section is installed at the downstream side than the two fixing devices. Therefore, it is impossible to prevent jam from occurring on the passage between the two fixing devices.

In Japanese Patent Unexamined Publication No. 2006-308889, since curl on a sheet which has passed through the fixing conveyance passage is corrected on a re-conveyance passage, it is possible to prevent jam from occurring on a conveyance passage after a sheet has passed through the two fixing devices. However, it is impossible to prevent jam from occurring on the passage between the two fixing devices.

If curl is caused on a sheet which has passed through an upstream side fixing device, when the sheet enter successively a downstream side fixing device, the entering attitude of the sheet does not stabilize. As a result, wrinkles of the sheet are caused. Further, in the case that the sheet cannot advance into a nip section of the downstream side fixing device due to the curl, the sheet causes jam at the nip section.

### SUMMARY OF THE INVENTION

The above-mentioned problems can be solved by the following structure to which one aspect of the present invention is reflected.

An image forming apparatus for conducting a fixing process by plural fixing devices for a sheet on which a toner image has been transferred, comprises:

a first fixing device arranged on a sheet conveyance passage;

a second fixing device arranged on the sheet conveyance passage at a downstream side of the first fixing device; and

a curl correcting section arranged on the sheet conveyance passage between the first fixing device and the second fixing device.

### BRIEF DESCRIPTION OF THE DRAWING

FIG. 1 is a cross sectional view showing the entire configuration of a image forming apparatus according to a first embodiment of the present invention.

FIG. 2 is a schematic view showing an outline structure of a fixing unit which comprises a first fixing device 9a, a second fixing device 9b, and a curl correcting section 11 in FIG. 1.

FIG. 3 is a flowchart showing an example of an operational procedure of the fixing unit shown in FIG. 2.

FIGS. 4a through 4f are cross sectional views showing examples of curl on a sheet P caused by a fixing process with the first fixing device 9a, FIGS. 4a through 4c show an example of an upward convex curl, and FIGS. 4d through 4f show an example of a downward convex curl.

FIG. 5 is a cross sectional view showing a situation that a sheet P on which a downward convex curl shown in FIG. 4f is formed by the first fixing device 9a advances into the second fixing device 9b.

FIG. 6 is a schematic diagram showing an outline structure of a fixing unit according to the second embodiment.

FIG. 7 is a flowchart showing an example of an operational procedure of the fixing unit shown in FIG. 6.

FIG. 8 is a table showing a concrete example of print information IF memorized in a memory section 31, FIG. 8a is a table showing the relationship between the kind of sheet P and a pressure to be applied to a sheet P at the time of curl correction, FIG. 8b is a table showing the relationship among the kind of sheet P, the basis weight of each kind, and a pressure to be applied to a sheet P at the time of curl correction, and FIG. 8c is a table showing the relationship among the kind of sheet P and a conveyance route, and a pressure to be applied to a sheet P at the time of curl correction.

FIG. 9 is a schematic diagram showing an outline structure of a fixing unit according to the third embodiment.

FIG. 10 is a flowchart showing an example of an operational procedure of the fixing unit shown in FIG. 9.

FIG. 11 is a schematic diagram showing an outline structure of a fixing unit according to the fourth embodiment.

FIG. 12 is a flowchart showing an example of an operational procedure of the fixing unit shown in FIG. 11.

FIG. 13 is a schematic diagram showing an outline structure of a fixing unit according to the fifth embodiment.

FIG. 14 is a flowchart showing an example of an operational procedure of the fixing unit shown in FIG. 13.

FIG. 15 is a schematic diagram showing an outline structure of a fixing unit according to a modification example.

### DETAILED DESCRIPTION OF THE PREFERRED EMBODIMENT

Hereafter, preferred embodiments according to the present invention will be explained. However, the present invention is not limited to these preferred embodiments.

First, an embodiment of the present invention will be described with reference to the drawings.

In the drawings, the same section is provided with the same reference symbol, and the description for it is omitted.

### First Embodiment

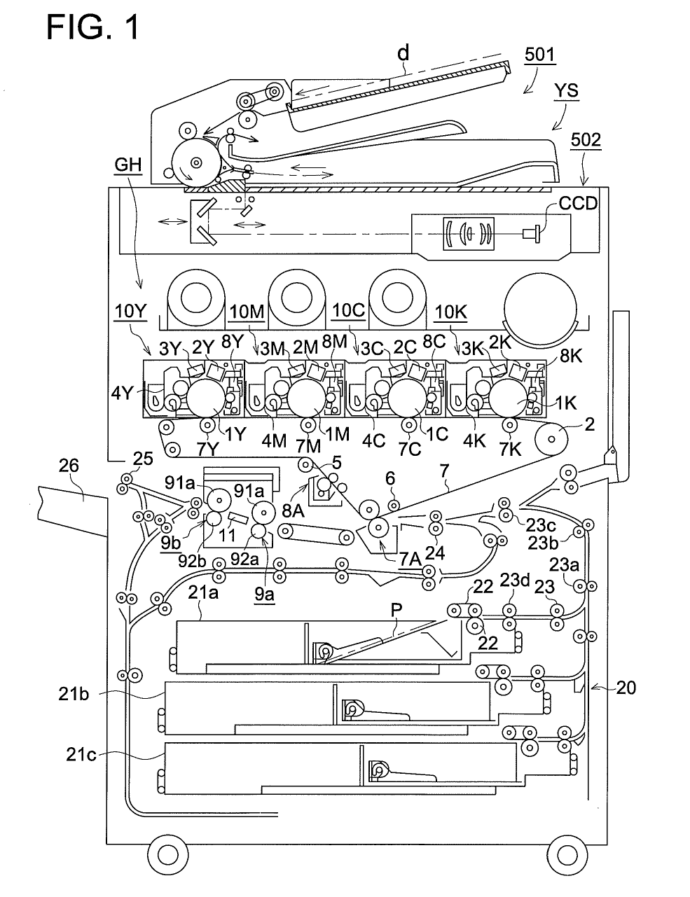

With reference to FIG. 1, the entire configuration of an image forming apparatus according to the first embodiment of the present invention will be explained. The image forming apparatus according to the first embodiment of the present invention is equipped with an image forming section GH and an image reading device YS. The image forming section GH is called a tandem type color image forming section, and is equipped with plural image forming units 10Y, 10M, 10C, and 10K prepared for each of plural colors, an intermediate transfer belt 7, and a secondary transferring section 7A.

On the upper portion of the image forming section GH, installed is the image reading apparatus YS which is constituted with an automatic document sheet feeding device 501 and a scanning exposure device 502. Document sheets placed on a document stand of the automatic document sheet feeding device 501 are conveyed sequentially by a conveying section, and images on one side or both sides of each of the document sheets are subjected to a scanning exposure process with an optical system of a scanning exposure device 502 in such a way that the images are read with a line image sensor CCD and photo-electrically converted into image signals.

Successively, the image signals produced by the photo-electrical conversion of the line image sensor CCD are subjected to an analog processing, an A/D conversion, a shading correction, an image compression processing, and the like in an image processing section, and then sent to exposing sections 3Y, 3M, 3C, and 3K.

The image forming unit 10Y to form images of yellow (Y) color comprises a charging section 2Y, an exposing section 3Y, a developing section 4Y, a primarily transferring section 7Y, and a cleaning section 8Y around a drum-shaped photoreceptor 1Y. The image forming unit 10M to form images of magenta (M) color comprises a charging section 2M, an exposing section 3M, a developing section 4M, a primarily transferring section 7M, and a cleaning section 8M around a drum-shaped photoreceptor 1M. The image forming unit 10C to form images of cyan (C) color comprises a charging section 2C, an exposing section 3C, a developing section 4C, a primarily transferring section 7C, and a cleaning section 8C around a drum-shaped photoreceptor 1C. The image forming unit 10K to form images of black (Bk) color comprises a charging section 2K, an exposing section 3K, a developing section 4K, a primarily transferring section 7K, and a cleaning section 8K around a drum-shaped photoreceptor 1K. In this structure, a combination of each of the charging section 2Y and the exposing section 3Y, the charging section 2M and the exposing section 3M, the charging section 2C and exposing section 3C, and the charging section 2K and the exposing section 3K constitutes a latent image formation section respectively.

The developing sections 4Y, 4M, 4C, and 4K accommodate developer including two components of toner of yellow (Y), Magenta (M), cyan (C), or black (K) and a carrier, respectively.

The intermediate transfer belt 7 is stretched over plural rollers 2, 3, 4, 5, and 6 are built over, and supported to be rotatable. A toner image of each of plural colors formed by the image forming units 10Y, 10M, 10C, and 10K is serially transferred onto the rotating intermediate transfer belt 7 by the primarily transferring sections 7Y, 7M, 7C, and 7K such that the toner images of plural colors are superimposed so as to form a color toner image on the intermediate transfer belt 7.

Sheets P accommodated in sheet feeding trays 21a to 21c are separated for every sheet by feeding rollers 22 of a sheet feeding section 20, and a sheet p is fed through feeding rollers 23a to 23e to a registering roller 24 on an stopping state. Then, the sheet P is stopped at the position of the registering roller 24. Subsequently, the registering roller 24 starts rotation at a timing to make the leading end of the sheet P to coincident with the position of the color toner image on the intermediate transfer belt 7, whereby the sheet P is conveyed by the registering roller 24 to the secondary transferring section 7A and the color toner image is secondarily transferred onto the sheet P. The sheet P on which the color toner image has been transferred is heated and applied with a pressure in the first fixing device 9a, and a second fixing device 9b, whereby the color toner image is fixed onto the sheet P.

On the other hand, after the color toner image has been transferred to the Sheet P by the secondary transferring section 7A, the sheet is separated with curvature from the intermediate transfer belt 7 and remaining toner on the intermediate transfer belt 7 is removed by a belt cleaning device 8A.

In the above, although the explanation has been made to the image forming apparatus to form a color image, the present invention is applicable also to an image forming apparatus to form a monochromatic image.

The first fixing device 9a comprises a fixing roller 91a and a pressing roller 92a, and heats and presses a color toner image on a sheet P at a nip section formed between the fixing roller 91a and the pressing roller 92a, thereby fixing the color toner image onto the sheet P. Similarly, the second fixing device 9b comprises a fixing roller 91b and a pressing roller 92b, and heats and presses a color toner image on a sheet P at a nip section formed between the fixing roller 91b and the pressing roller 92b, thereby fixing the color toner image onto the sheet P. A curl correcting section 11 is arranged on a sheet carrying passage between the first fixing device 9a and the second fixing device 9b, and the curl correcting section 11 applies a pressure to a sheet P which has passed the first fixing device 9a, and corrects a curl produced on the sheet P by the first fixing device 9a. Here, the first fixing device 9a, the second fixing device 9b, and the curl correcting section 11 are collectively called a “fixing unit”.

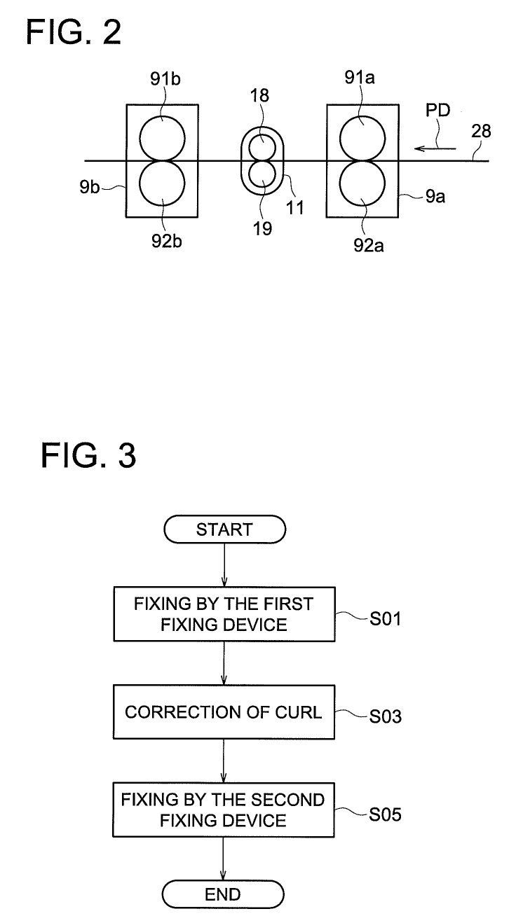

With reference to FIG. 2, the outline structure of the fixing unit, shown in FIG. 1, which is constituted with the first fixing device 9a, the second fixing device 9b, and the curl correcting section 11 is explained. The image forming apparatus shown in FIG. 1 performs a fixing process for a sheet P, on which a toner image has been transferred, by using plural fixing devices. As an example of the plural fixing devices, an explanation will be made about the case where an image forming apparatus is equipped with two fixing devices 9a and 9b.

Concretely, the image forming apparatus comprises: the first fixing device 9a arranged on the sheet conveying passage 28, the second fixing device 9b arranged on the sheet conveying passage28 at the downstream than the first fixing device 9a, and the curl correcting section 11 arranged on the sheet conveying passage28 between the first fixing device 9a and the second fixing device 9b and to correct a curl caused on a sheet P by applying pressure on the sheet P. The first fixing device 9a and the second fixing device 9b conduct a fixing process to apply heat and pressure to a sheet P on which a color toner image has been transferred, respectively. With this fixing process, toner on a sheet P is melted, whereby a toner image is fixed onto the sheet P. When the fixing process is conducted two times for a sheet P with the two fixing devices 9a and 9b, the fixing ability and glossiness of a toner are improve. The curl correcting section 11 comprises a pair of the upper side pressing roller 18 and the lower side pressing roller 19 and corrects a curl by applying a pressure to a sheet P with the upper side pressing roller 18 and the lower side pressing roller 19.

A color toner image is transferred onto a sheet P in the secondary transferring section 7A shown in FIG. 1, and the sheet P is conveyed in the sheet conveying direction PD on the sheet conveying passage 28, and reaches the first fixing device 9a first. Then, the sheet P on which a fixing process has been applied by the first fixing device 9a is again conveyed in the sheet conveying direction PD on the sheet conveying passage 28, and next, reaches the curl correcting section 11. Successively, the sheet P to which the curl correcting process has been applied by the curl correcting section 11 is again conveyed in the sheet conveying direction PD on the sheet conveying passage 28, and next, the sheet P reaches the second fixing device 9b, and then, a fixing process is conducted for the sheet P by the second fixing device 9b.

In this way, the first fixing device 9a, the curl correcting section 11, and the second fixing device 9b are arranged serially on the sheet conveying passage28. In other words, the first fixing device 9a, the curl correcting section 11, and the second fixing device 9b are connected in series by the sheet conveying passage28. That is, in view from the upstream side in the sheet conveying direction PD, the first fixing device 9a, the curl correcting section 11, and the second fixing device 9b are arranged in this order from the upstream side.

The distance of the sheet conveying passage 28 between the first fixing device 9a and the second fixing device 9b is set equal to or less than the length, in the conveying direction, of a sheet P of the maximum size which the image forming apparatus can cope with. If the distance of the sheet conveying passage 28 between the first fixing device 9a and the second fixing device 9b is made long excessively, the temperature of a sheet P will is lowered while the sheet P is conveyed from the fixing device 9a at the upstream side to the fixing device 9b at the downstream side. As a result, improvements in fixability and glossiness in the fixing process by the fixing device 9b at the downstream side will decrease. On the other hand, if the distance of the sheet conveying passage 28 between the first fixing device 9a and the second fixing device 9b is made short excessively, a sheet P is pulled between two fixing devices 9a and 9b and this pulling force may cause breakage of the sheet P and the like.

Therefore, it is desirable that the distance of the sheet conveying passage 28 between the first fixing device 9a and the second fixing device 9b is longer to an extent that a sheet P to be conveyed is not pulled between these first and second fixing devices 9a, 9b, and is shorter to an extent that the temperature of a sheet P is not lowered too much while the sheet P is conveyed from the fixing device 9a at the upstream to the fixing device 9b at the downstream.

In addition to the distance between the fixing device 9a and 9b, the lowering of the temperature of a sheet P is also related to speed at which the sheet P is conveyed. Therefore, if the conveying speed is fast, the distance of the sheet conveying passage 28 between the first fixing device 9a and the second fixing device 9b may be made long in accordance with the conveying speed. However, if the distance of the sheet conveying passage 28 between the first fixing device 9a and the second fixing device 9b is made short, since the size of the entire body of the fixing unit including the first and second fixing devices 9a and 9b can be made small, it is desirable, because it becomes possible to save the space of the image forming apparatus and to make the size of the image forming apparatus small. Moreover, at the same time, if the conveying speed is fast, the processing speed in the fixing unit becomes fast, and the throughput of the image forming apparatus can be improved.

With reference to FIG. 3, an example of an operational procedure of the fixing unit shown in FIG. 2 will be explained. First, at Step S01, the first fixing device 9a conducts a fixing process to a sheet P on which a color toner image has been transferred in a second transfer process. Then, the operational procedure proceeds to Step S03, the curl correcting section 11 conducts a curl correcting process for the sheet P for which the fixing process has been conducted by the first fixing device 9a. Finally, at Step 505, the second fixing device 9b conducts a fixing process again to the sheet P for which the curl correcting process has been conducted.

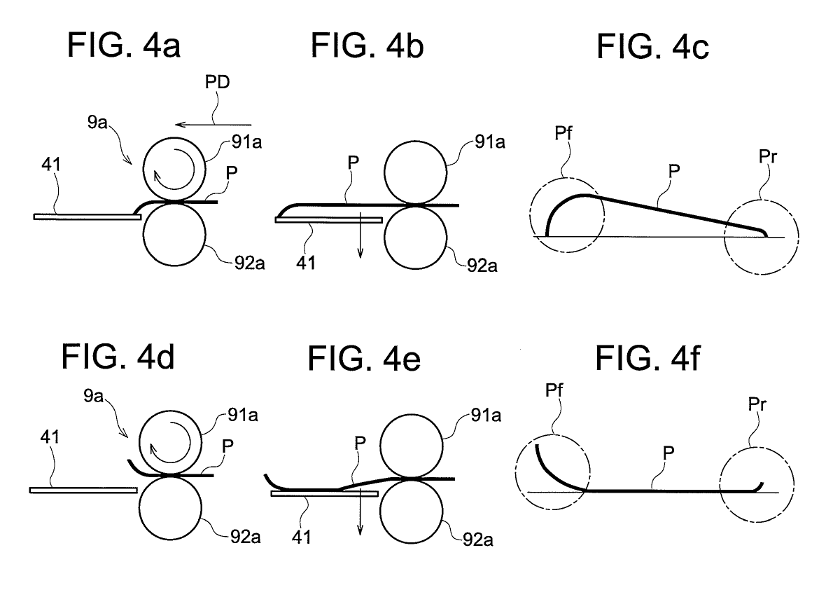

With reference to FIGS. 4a through 4f, an explanation will be made about a curl caused on a sheet P on the fixing process with the first fixing device 9a. A curl caused on a sheet P for which a fixing process has been conducted may take various shapes in accordance with an extent of moisture absorption of the sheet P and an amount of toner and a distribution of toner on the sheet P. For example, a sheet P on which a fixing process has been applied will curve toward the image forming surface side by the heat contraction of toner. On the other hand, on a margin portion of the sheet where toner has not adhered and on a portion where an amount of adhered toner is comparatively small, moisture of the sheet P evaporates by the heat of the first fixing device 9a, and then the sheet P will curve in the direction opposite to the image forming surface side. Then, FIGS. 4a through 4c show an example of an upward convex-shaped curl generated at the leading end and trailing end of a sheet P, and FIGS. 4d through 4f show an example of a downward convex-shaped curl generated at the leading end and trailing end of a sheet P.

As shown in FIG. 4a, when the leading end of a sheet P has passed the nip section of the first fixing device 9a, the sheet P will reach the conveyance guide plate 41 on the condition that the leading end of the sheet P curls toward the lower side. At this time, the curl formed on the leading end of the sheet P is on a free condition without being regulated. As shown in FIG. 4b, when the trailing end of the sheet P approaches the nip section of the first fixing device 9a, a force working in the direction of an arrowed mark ↓ will be added in the vicinity of the gravity center of a sheet P by the weight of the sheet P and the bending of the sheet P, and this force will work in the direction to correct an upward convex curl. As shown in FIG. 4c, when the trailing end Pr of the sheet P has passed the nip section of the first fixing device 9a, an upward convex curl will be formed at the leading end Pf and the trailing end Pr of the sheet P, respectively. The reason why the amount of curl at the trailing end Pr becomes smaller than that at the leading end Pf is that the force mentioned above is added in the direction to correct an upward convex curl.

Similarly, as shown in FIG. 4d, the leading end of a sheet P has passed the nip section of the first fixing device 9a, the sheet P will reach the conveyance guide plate 41 on the condition that the leading end of the sheet P curls toward the upper side. At this time, the curl formed on the leading end of the sheet P is on a free condition without being regulated. As shown in FIG. 4e, when the trailing end of the sheet P approaches the nip section of the first fixing device 9a, a force working in the direction of an arrowed mark twill be added in the vicinity of the gravity center of Sheet P by the weight of the sheet P and the bending of the sheet P, and this force will work in the direction to correct a downward convex curl. As shown in FIG. 4f, when the trailing end Pr of the sheet P has passed the nip section of the first fixing device 9a, a downward convex curl will be formed at the leading end Pf and the trailing end Pr of the sheet P, respectively. The reason why the amount of curl at the trailing end Pr becomes smaller than that at the leading end Pf is that the force mentioned above is added in the direction to correct a downward convex curl.

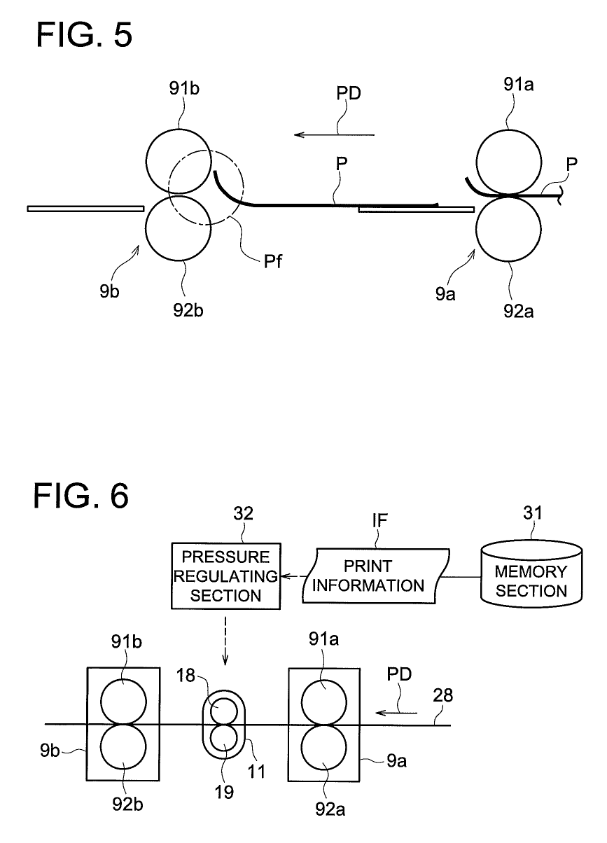

With reference to FIG. 5, an explanation will be made about wrinkles and jams of a sheet P which occurs at the time that a sheet on which a downward convex curl shown in FIG. 4f is formed by the first fixing device 9a enters the second fixing device 9b. FIG. 5 shows a situation that a sheet P on which a downward convex curl is formed by the first fixing device 9a has reached the second fixing device 9b with a downward convex curl having been not corrected between the first fixing device 9a and the second fixing device 9b. When the leading end Pf of the sheet P on which the downward convex curl is formed comes to the nip section of the second fixing device 9b, the entering attitude of the sheet P to the nip section of the second fixing device 9b is not stabilized due to the downward convex curl. Accordingly, wrinkles may occur on the sheet P at the time that the sheet passes through the second fixing device 9b. Moreover, in the case that the sheet P cannot enter the nip section of the second fixing device 9b by the downward convex curl, sheet jam may take place. As for a sheet P with a small basis weight, generally curl becomes large and wrinkles and jam of a sheet P become remarkable.

Then, for example, the curl correcting section 11 shown in FIG. 2 may be structured such that the upper side pressing roller 18 is made in a soft roller and the lower side pressing roller 19 is made in a hard roller with a high hardness and a nip portion formed between the upper side pressing roller 18 and the lower side pressing roller 19 is shipped in an upward convex. With this structure, at Step S303 in FIG. 3, the curl correcting section 11 applies a pressure in the form of the upward convex onto the downward convex curl of a sheet P, whereby a curl of a sheet P can be corrected.

According to the first embodiment of the present invention, the following works and effects can be obtained.

When curl caused in the fixing device 9a at the upstream side is corrected before the fixing device 9b at the downstream side, it becomes possible to prevent wrinkles and jam of a sheet P from taking place at the entrance of the fixing device 9b at the downstream side. Moreover, at the same time, when a sheet P is subjected to a fixing process twice by the use of two fixing devices, the glossiness of the sheet P can be enhanced.

The distance of the sheet conveying passage 28 between the first fixing device 9a and the second fixing device 9b is made equal to or less than the length, in the conveying direction, of a sheet P with the maximum size which the image forming apparatus can cope with. With this, the lowering of the temperature of a sheet P conveyed from the fixing device 9a at the upstream side to the fixing device 9b at the downstream side can be suppressed so that the temperature of the sheet P conveyed to the fixing device 9b at the downstream side can be maintained at a high temperature properly. Therefore, the glossiness can be increased more by the fixing process in the fixing device 9b at the downstream side. Furthermore, the entire body of the fixing unit including the first fixing device 9a and the second fixing device 9b can be miniaturized.

Generally, when the temperature of a sheet P which has been once heated by the fixing process is lowered, a curl becomes noticeable. For this, as mentioned above, in this embodiment, the distance of the sheet conveying passage 28 between the first fixing device 9a and the second fixing device 9b is set such that the lowering of the temperature of a sheet P conveyed from the fixing device 9a at the upstream side to the fixing device 9b at the downstream side can be suppressed. With this arrangement, the curl correcting section 11 is located between the first fixing device 9a and the second fixing device 9b, the curl correcting section 11 can correct curl efficiently before the temperature of a sheet P is lowered.

### Second Embodiment

In the second embodiment, an explanation will be made about the image forming apparatus in which the curl correcting section 11 further comprises a pressure regulating section 32 to adjust the pressure applied onto a sheet P based on an image forming condition.

With reference to FIG. 6, an outline structure of a fixing unit according to the second embodiment will be explained. FIG. 6 is a figure corresponding to FIG. 2 in the first embodiment. Since the entire configuration of the image forming apparatus except the fixing unit according to the second embodiment is the same as that in FIG. 1, an illustration and an explanation about the entire configuration are omitted.

The image forming apparatus according to the second embodiment comprises: a first fixing device 9a arranged on the sheet conveying passage 28, a second fixing device 9b arranged on the sheet conveying passage 28 at the downstream than the first fixing device 9a, a curl correcting section 11 arranged on the sheet conveying passage 28 between the first fixing device 9a and the second fixing device 9b and to correct a curl caused on a sheet P by applying pressure on the sheet P, a pressure adjusting section 32 to adjust based on an image forming condition the pressure that the curl correction section 11 applies onto the sheet P, and a memory section 31 to memorize print information IF indicating the image forming condition. The pressure adjusting section 32 reads out the print information IF from the memory section 31.

Here, the image forming condition indicated by the print information IF includes the characteristics of the sheets P, such as a size a kind, a thickness, and a basis weight of a sheet P and various printing conditions including single side printing, double side printing and the like.

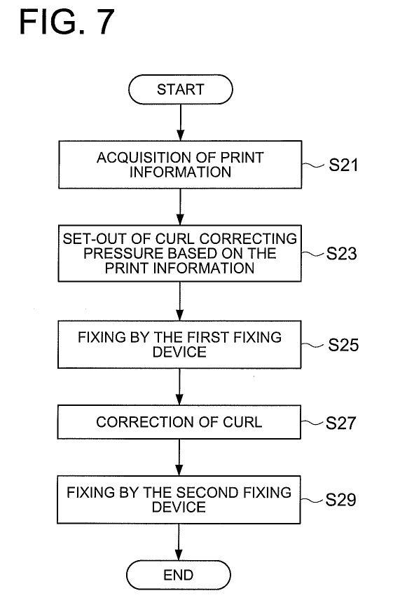

With reference to FIG. 7, an example of an operational procedure of the fixing unit shown in FIG. 6 will be explained. First, at Step S21, the pressure adjusting section 32 reads out the print information IF from the memory section 31. Then, the operational procedure proceeds to Step S23, the pressure adjusting section 32 sets up a pressure to be applied to a sheet P based on the print information IF. Subsequently, the operational procedure proceeds to Step S25, the first fixing device 9a conducts a fixing process to a sheet P on which a color toner image has been transferred in a second transfer process. Then, the operational procedure proceeds to Step S27, the curl correcting section 11 conducts a curl correcting process with the pressure set at Step S23 for the sheet P for which the fixing process has been conducted by the first fixing device 9a. Finally, at Step S29, the second fixing device 9b conducts a fixing process again to the sheet P for which the curl correcting process has been conducted.

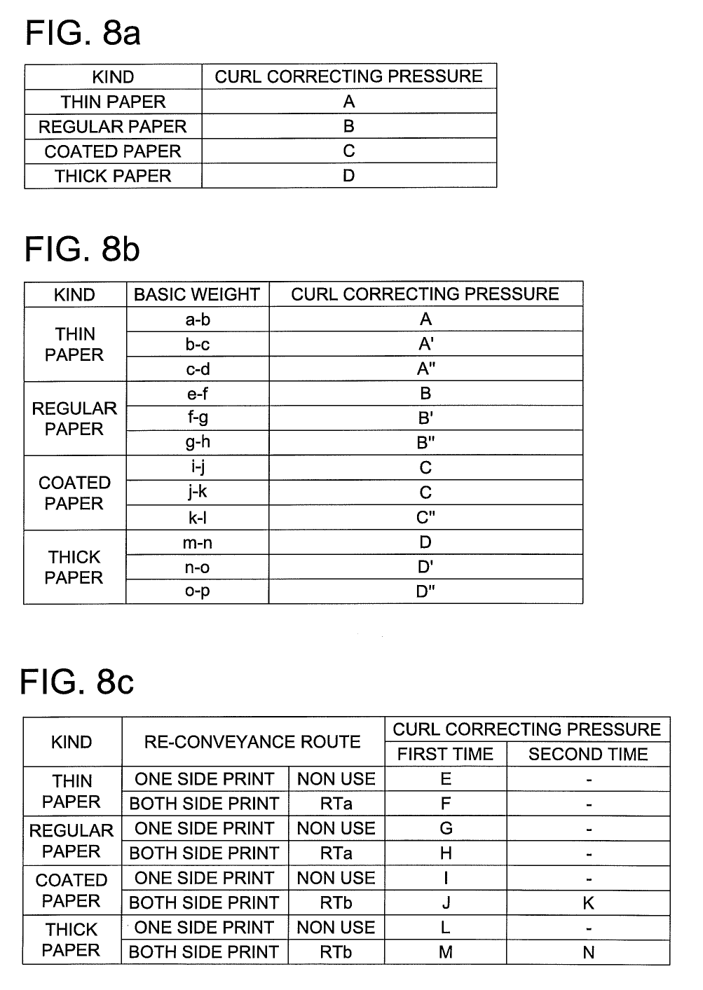

FIGS. 8a through 8c each shows a table indicating a concrete example of print information IF memorized in the memory section 31. FIG. 8a shows a table showing a relationship between a kind of sheet P and a pressure to be applied to a sheet P at the time of curl correction. FIG. 8b shows a table showing a relationship among a kind of sheet P, the basis weight of each kind of sheet P, and a pressure to be applied to a sheet P at the time of curl correction. FIG. 8c shows a table showing a relationship among a kind of sheet P, conveyance route for one-side print and both-side print, and a pressure to be applied to a sheet P at the time of curl correction.

The pressure adjusting section 32 may select and set up a pressure to be applied to a sheet P from A to D based on table data shown in FIG. 8a. Alternatively, the pressure adjusting section 32 may select and set up a pressure to be applied to a sheet P from A to D, A′ to D′, and A″ to D″ based on table data shown in FIG. 8a. Here, the table data shown in FIG. 8c will be explained in the third embodiment.

According to the second embodiment of the present invention, the following works and effects can be obtained.

Although an amount of curl caused in the fixing process may change in accordance with an image forming condition according to an image forming condition, since the image forming apparatus further comprises the pressure regulating section 32 to adjust based on an image forming condition a pressure which the curl correcting section 11 applies onto a sheet P, proper curl correction can be conducted based on the image forming condition.

### Third Embodiment

In the third embodiment, an explanation will be made about the image forming apparatus equipped with a first re-conveying passage RTa which is made to branch from the sheet conveying passage 28 between the first fixing device 9a and the curl correcting sections 11 and is used to convey a sheet P again to the secondary transferring section 7A to transfer a toner image on the sheet P.

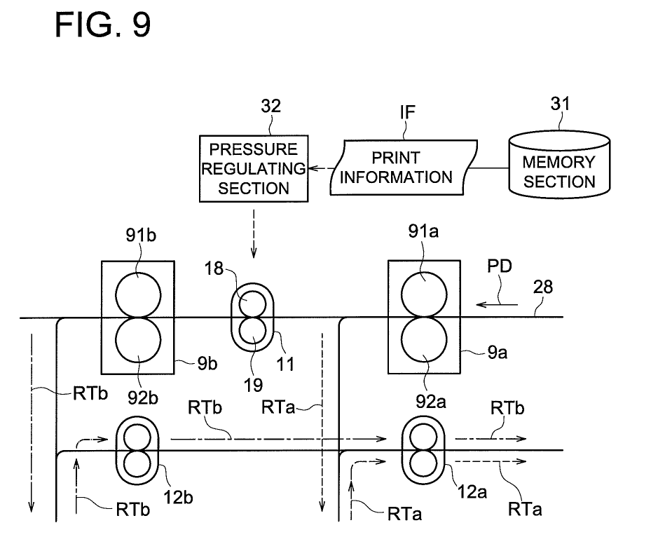

With reference to FIG. 9, an outline structure of a fixing unit according to the third embodiment will be explained. FIG. 9 is a figure corresponding to FIG. 6 in the second embodiment. Since the entire configuration of the image forming apparatus except the fixing unit according to the third embodiment is the same as that in FIG. 1, an illustration and an explanation about the entire configuration are omitted.

The image forming apparatus according to the third embodiment comprises: a first fixing device 9a arranged on the sheet conveying passage 28, a second fixing device 9b arranged on the sheet conveying passage28 at the downstream than the first fixing device 9a, a curl correcting section 11 arranged on the sheet conveying passage28 between the first fixing device 9a and the second fixing device 9b and to correct a curl caused on a sheet P by applying pressure on the sheet P, a pressure adjusting section 32 to adjust based on an image forming condition the pressure that the curl correction section 11 applies onto the sheet P, a memory section 31 to memorize print information IF indicating the image forming condition, a first re-conveying passage RTa made to branch from the sheet conveying passage 28 between the first fixing device 9a and the curl correcting sections 11, a second re-conveying passage RTb made to branch from the sheet conveying passage 28 at the downstream side than the second fixing device 9b, a curl correcting section 12a provided on the first re-conveying passage RTa, and a curl correcting section 12b provided on the second re-conveying passage RTb.

The image forming apparatus changes a passage route to convey a sheet in accordance with information of one side printing or double-side printing from the sheet conveying passage28 to the first re-conveying passage RTa or to the second re-conveying passage RTb. The first re-conveying passage RTa is used in the case where double-side printing is conducted for thin paper, regular paper and the like, and is a passage to convey the sheet P having passed the first fixing device 9a again to the secondary transferring section 7A. The curl correcting section 12a corrects curl caused by a fixing process with the first fixing device 9a on the first re-conveying passage RTa. On the other hand, the second re-conveying passage RTb is used in the case where double-side printing is conducted for thick paper, coated paper and the like, and is a passage to convey the sheet P having passed the second fixing device 9b again to the secondary transferring section 7A. The curl correcting section 12b corrects curl caused by a fixing process with the second fixing device 9b on the second re-conveying passage RTb.

Since other structures are the same as those in the second embodiment, description for the other structures is omitted.

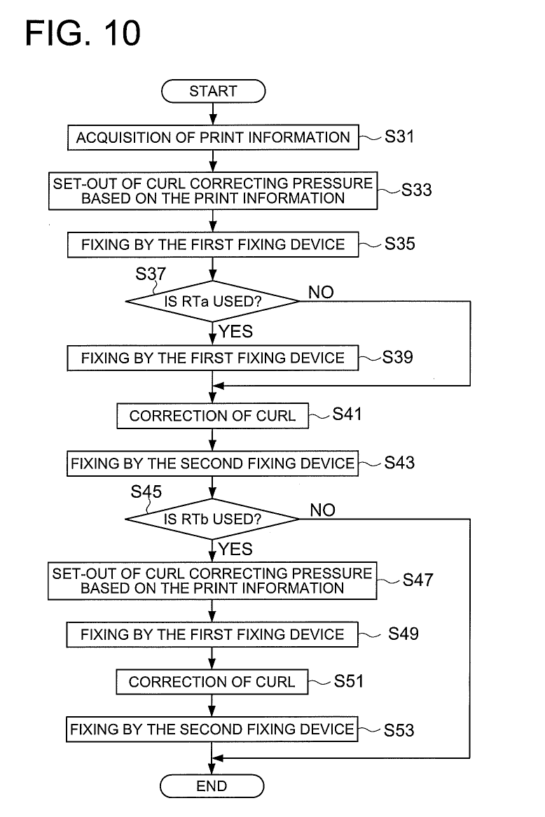

With reference to FIG. 10, an example of an operational procedure of the fixing unit shown in FIG. 9 will be explained.

(A) First, at Step S31, the pressure adjusting section 32 reads out the print information IF from the memory section 31. Then, the operational procedure proceeds to Step S33, the pressure adjusting section 32 sets up a pressure to be applied to a sheet P based on the print information IF. Subsequently, the operational procedure proceeds to Step S35, the first fixing device 9a conducts a fixing process to a sheet P on an obverse side surface of which a color toner image has been transferred in the second transfer process.

(B) The operational procedure proceeds to Step S37, in the case where a double-side printing is conducted and in the case where the sheet P which has passed through the first fixing device 9a is conveyed again to the secondary transferring section 7A (YES at S37), the sheet P is conveyed to the first re-conveying passage RTa, and a toner image is transferred onto the reverse side surface of the sheet P in the secondary transferring section 7A. Thereafter, the operational procedure proceeds to Step S39, in the first fixing device 9a, a fixing process is conducted again for the sheet P onto a reverse side surface of which the color toner image has been transferred at the secondary transferring section 7A. Then, the operational procedure proceeds to Step S41, the curl correcting section 11 conducts a curl correcting process with the pressure set at Step S33 only one time for the sheet P for which the fixing process has been conducted by the first fixing device 9a, so that toner images have been fixed onto the both side surfaces of the sheet P. On the other hand, in the case that the first re-conveying passage RTa is not used (NO at Step S37), the operational procedure proceeds directly to Step S41, and at Sep S41, the curl correcting section 11 conducts the first curl correcting process (first time) with the pressure set at Step S33 for the sheet P for which the fixing process has been conducted by the first fixing device 9a.

(C) The operational procedure proceeds directly to Step S43, the second fixing device 9b conducts a fixing process again to the sheet P for which the curl correcting process has been conducted. Then, the operational procedure proceeds to Step S45, in the case where a double-side printing is conducted and a sheet P which has passed through the second fixing device 9b is conveyed again to the secondary transferring section 7A (YES at Step S45), the sheet P is conveyed to the second re-conveying passage RTb, and a toner image is transferred onto the reverse side surface of the sheet P in the secondary transferring section 7A. On the other hand, in the case that the second re-conveying passage RTb is not used (NO at Step S45), that is, for the sheet P in which toner images have been formed onto the both side surfaces through the first re-conveying passage RTa, the flowchart shown in FIG. 10 is ended.

(D) In the case where a double-side printing is conducted, for the sheet which has been conveyed to the second re-conveying passage RTb and carries a toner image transferred onto its reverse side surface, the operational procedure proceeds to Step S47, the pressure adjusting section 32 sets up a pressure to be applied onto the sheet P based on the print information IF. At this stage, since curl related to the fixing process for the color toner image formed on the obverse side surface has be already subjected to the first curl correcting process (first time), another curl related to the fixing process for the color toner image formed on the reverse side surface is subjected to the second curl correcting process (second time). Therefore, for example, in FIG. 8c, thicker paper is used as a sheet P, and the second re-conveying passage RTb is selected as a conveyance route, at Step S33, a pressure (curl correcting pressure) is set to “M” for the first curl correcting process (first time), and at Step S47, a pressure (curl correcting pressure) is set to “N” for the second curl correcting process (second time) so that different pressures can be set in this embodiment. Next, the operational procedure proceeds directly to Step S49, the first fixing device 9a conducts a fixing process for the sheet P onto a reverse side surface of which the color toner image has been transferred at the secondary transferring section 7A. The operational procedure proceeds to Step S51, the curl correcting section 11 conducts the second curl correcting process (second time) with the pressure set up at Step S47 for the sheet P for which the fixing process has been conducted by the first fixing device 9a. Finally, in Step S53, the second fixing device 9b conducts a fixing process again to the sheet P for which the curl correcting process has been conducted.

Further, in the case that the first re-conveying passage RTa is used (YES at Step S37), a curl correcting section 12a may conduct a curl correcting process with a pressure set up at Step S33 on the first re-conveying passage RTa for the sheet P for which the fixing process was conducted by the first fixing device 9a. Similarly, in the case that the second re-conveying passage RTb is used (YES at Step S45), a curl correcting section 12b may conduct a curl correcting process on the second re-conveying passage RTb for the sheet P for which the fixing process was conducted by the second fixing device 9b. The curl correcting section 12a and the curl correcting section 12b may be provided with a roller pressure contact releasing mechanism. Accordingly, when a curl correcting process is not required, the pressure contact between the upper and lower pressing rollers is released by the roller pressure contact releasing mechanism so that a sheet P passes through a gap between the upper and lower pressing rollers,

As mentioned above, in Step S47, the pressure to be applied to the sheet P may be set up based on the table data shown in FIG. 8c as an example of the print information IF. That is, in Step S47 step, since the curl correcting process is conducted for the curl caused at the time when a fixing process is conducted for the sheet P on which a toner image is formed on the reverse side surface, a pressure “K” or “N” indicated at the columns of Second time of Curl correcting pressure in FIG. 8c may be set up for the second curl correcting process in Step S47. Further, since the conveyance route at the time of a double-side printing is designated in accordance with the kind of sheet P as shown in FIG. 8c, the conveyance route at the time of a double-side printing may be determined in accordance with the table data shown in FIG. 8c. For example, when the kind of sheet P is coated paper, the second re-conveying passage RTb is selected as the conveyance route for the double-side printing. Further, when the curl correcting process is conducted at Step S47, since the curl correcting process is the second time, a pressure of “K” is selected as the curl correcting pressure.

At the time of setting the data in FIGS. 8a, 8b and 8c, the following points may be considered.

(1) For thick paper, a curl correcting pressure is made high as compared with thin paper.

(2) Since in both side printing, a fixing process is conducted for both side surfaces, a curl correcting pressure is made low as compared with one side printing.

(3) In both side printing, a curl amount at the time of the first side printing (at the time of forming an image on a obverse side surface) is larger than that at the time of the second side printing (at the time of forming an image on a reverse side surface), a curl correcting pressure for the first side printing is made high than that for the second side printing.

Moreover, a curl correcting pressure may be determined with consideration for various factors in addition to the above points in view of image forming conditions. Therefore, since data determined based on such considerations may be stored, the curl correcting can be conducted efficiently.

### Fourth Embodiment

In the fourth embodiment, an explanation will be made about an image forming apparatus equipped with a first re-conveying passage RTa′ which is made to branch from the sheet conveying passage 28 between the curl correcting sections 11 and the second fixing device 9b and is used to convey a sheet P again to the secondary transferring section 7A to transfer a toner image on the sheet P.

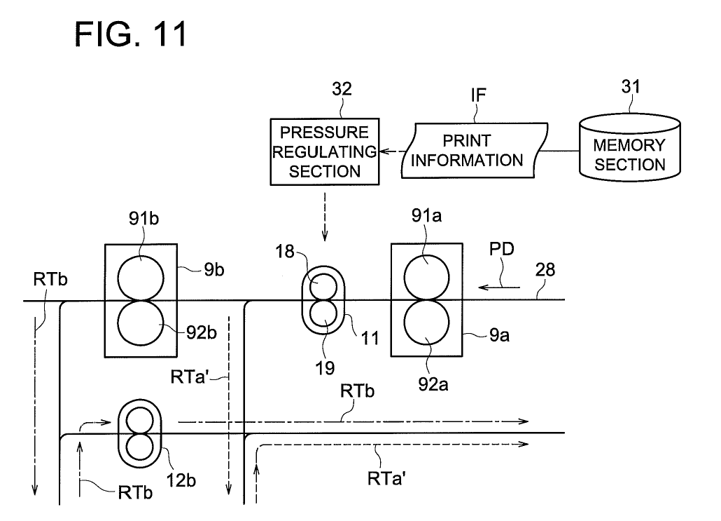

With reference to FIG. 11, an outline structure of a fixing unit according to the fourth embodiment will be explained. FIG. 11 is a figure corresponding to FIG. 9 in the third embodiment. Since the entire configuration of the image forming apparatus except the fixing unit according to the fourth embodiment is the same as that in FIG. 1, an illustration and an explanation about the entire configuration are omitted.

The image forming apparatus according to the fourth embodiment comprises: a first fixing device 9a arranged on the sheet conveying passage 28, a second fixing device 9b arranged on the sheet conveying passage28 at the downstream than the first fixing device 9a, a curl correcting section 11 arranged on the sheet conveying passage28 between the first fixing device 9a and the second fixing device 9b and to correct a curl caused on a sheet P by applying pressure on the sheet P, a pressure adjusting section 32 to adjust based on an image forming condition the pressure that the curl correction section 11 applies onto the sheet P, a memory section 31 to memorize print information IF indicating the image forming condition, a first re-conveying passage RTa′ made to branch from the sheet conveying passage 28 between the curl correcting sections 11 and the second fixing device 9a, a second re-conveying passage RTb made to branch from the sheet conveying passage 28 at the downstream side than the second fixing device 9b, and a curl correcting section 12b provided on the second re-conveying passage RTb.

The image forming apparatus changes a conveyance route to convey a sheet in accordance with information of one side printing or double-side printing from the sheet conveying passage28 to the first re-conveying passage RTa′ or to the second re-conveying passage RTb. The first re-conveying passage RTa′ is used in the case where double-side printing is conducted, and is a passage to convey the sheet P having passed the curl correcting section 11 again to the secondary transferring section 7A. On the other hand, the second re-conveying passage RTb is used in the case where double-side printing is conducted, and is a passage to convey the sheet P having passed the second fixing device 9b again to the secondary transferring section 7A. The curl correcting section 12b corrects curl caused by a fixing process with the second fixing device 9b on the second re-conveying passage RTb. In this embodiment, a member to correct curl is not arranged on the first re-conveying passage RTa′.

Since other structures are the same as those in the third embodiment, description for the other structures is omitted.

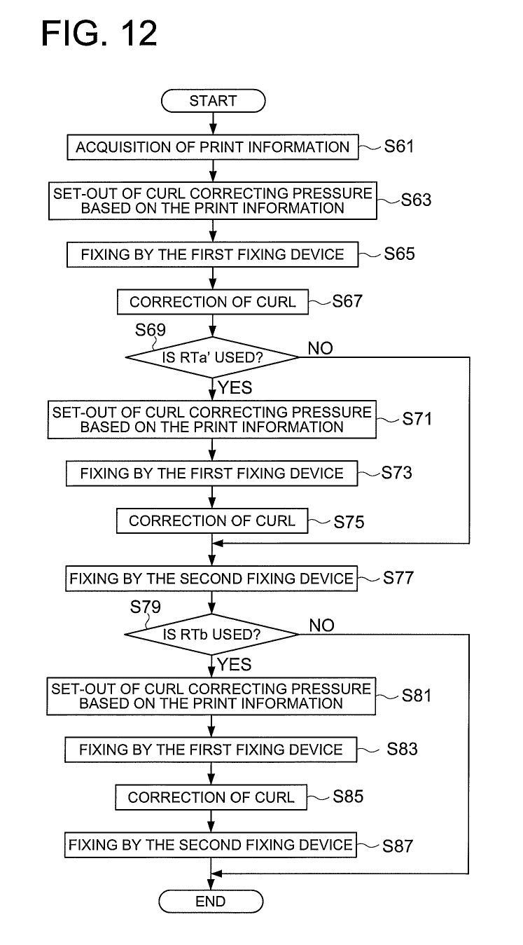

With reference to FIG. 12, an example of an operational procedure of the fixing unit shown in FIG. 11 will be explained.

(A) First, at Step S61, the pressure adjusting section 32 reads out the print information IF from the memory section 31. Then, the operational procedure proceeds to Step S63, the pressure adjusting section 32 sets up a pressure to be applied to a sheet P based on the print information IF. Subsequently, the operational procedure proceeds to Step S65, the first fixing device 9a conducts a fixing process to a sheet P on the obverse side surface of which a color toner image has been transferred in the second transfer process.

(B) The operational procedure proceeds to Step S67, the curl correcting section 11 conducts the first curl correcting process (first time) with the pressure set at Step S63 for the sheet P for which the fixing process has been conducted by the first fixing device 9a. Then, the operational procedure proceeds to Step S69, in the case where a double-side printing is conducted and in the case where the sheet P which has passed through the curl correcting section 11 is conveyed again to the secondary transferring section 7A (YES at Step S69), the sheet P is conveyed to the first re-conveying passage RTa′, and a toner image is transferred onto the reverse side surface of the sheet P in the secondary transferring section 7A. Thereafter, the operational procedure proceeds to Step S71. On the other hand, in the case that the first re-conveying passage RTa′ is not used, the operational procedure proceeds directly to Step S77.

(C) For the sheet on the reverse side surface of which a toner image has been transferred through the conveyance route of the first re-conveying passage RTa′, at Step S47, the curl correcting section 11 sets up a pressure to be applied onto the sheet P based on the print information IF. The operational procedure proceeds to Step S73, the first fixing device 9a conducts a fixing process for the sheet P onto which the color toner image has been transferred at the second transfer process. The operational procedure proceeds directly to Step S75, the curl correcting section 11 conducts the second curl correcting process (second time) with the pressure set up at Step S71 for the sheet P for which the fixing process has been conducted by the first fixing device 9a.

(D) The operational procedure proceeds to Step S77, the second fixing device 9b conducts a fixing process again to the sheet P for which the curl correcting process has been conducted. Then, the operational procedure proceeds to Step S79, in the case where a double-side printing is conducted and in the case that a sheet P which has passed through the second fixing device 9b is conveyed again to the secondary transferring section 7A (YES at Step S79), the sheet P is conveyed to the second re-conveying passage RTb, and a toner image is transferred onto the reverse side surface of the sheet P in the secondary transferring section 7A. Thereafter, the operational procedure proceeds to Step S81. On the other hand, in the case that the second re-conveying passage RTb is not used (NO at Step S79), that is, for the sheet on the reverse side surface of which a toner image has been transferred through the conveyance route of the first re-conveying passage RTa′, the flowchart shown in FIG. 12 is ended.

(E) For the sheet on the reverse side surface of which a toner image has been transferred through the conveyance route of the second re-conveying passage RTb, at Step S81, the curl correcting section 11 sets up a pressure to be applied to a sheet P based on the print information IF. Then, the operational procedure proceeds to Step S83, the first fixing device 9a conducts a fixing process to the sheet P on which a color toner image has been transferred in the second transfer process. Subsequently, the operational procedure proceeds to Step S85, the curl correcting section 11 conducts the second curl correcting process (second time) with the pressure set at Step S81 for the sheet P for which the fixing process has been conducted by the first fixing device 9a. Finally, at Step S87, the second fixing device 9b conducts a fixing process again to the sheet P for which the curl correcting process has been conducted.

Further, in the case that the second re-conveying passage RTb is used (YES at Step S77), a curl correcting section 12b may conduct a curl correcting process on the second re-conveying passage RTb for the sheet P for which the fixing process was conducted by the second fixing device 9b.

According to the fourth embodiment of the present invention, the following works and effects can be obtained.

With the structure that the first re-conveying passage RTa′ to convey a sheet P again to the secondary transferring section 7A to transfer a toner image onto the sheet P is provided so as to branch from the sheet conveying passage28 between the curl correcting section 11 and the second fixing device 9b, since curl on a sheet P conveyed to the first re-conveying passage RTa′ is corrected by the curl correcting section 11, there is no need to provide another curl correcting section separately on the first re-conveying passage RTa′.

### Fifth Embodiment

In the fifth embodiment, an explanation will be made about an image forming apparatus equipped with only a second re-conveying passage RTb, which is made to branch from the sheet conveying passage 28 at a downstream side than the second fixing device 9b, as a passage to convey a sheet P again to the secondary transferring section 7A.

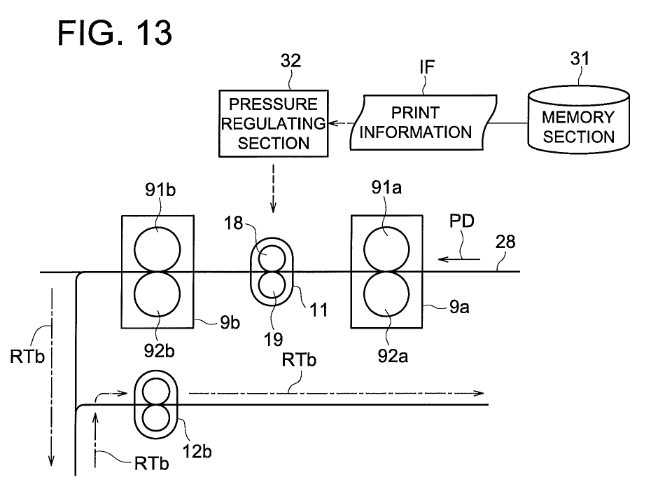

With reference to FIG. 13, an outline structure of a fixing unit according to the fifth embodiment will be explained. FIG. 13 is a figure corresponding to FIG. 11 in the fourth embodiment. Since the entire configuration of the image forming apparatus except the fixing unit according to the fifth embodiment is the same as that in FIG. 1, an illustration and an explanation about the entire configuration are omitted.

The image forming apparatus according to the fourth embodiment comprises: a first fixing device 9a arranged on the sheet conveying passage 28, a second fixing device 9b arranged on the sheet conveying passage28 at the downstream than the first fixing device 9a, a curl correcting section 11 arranged on the sheet conveying passage28 between the first fixing device 9a and the second fixing device 9b and to correct a curl caused on a sheet P by applying pressure on the sheet P, a pressure adjusting section 32 to adjust based on an image forming condition the pressure that the curl correction section 11 applies onto the sheet P, a memory section 31 to memorize print information IF indicating the image forming condition, a second re-conveying passage RTb made to branch from the sheet conveying passage 28 at the downstream side than the second fixing device 9b, and a curl correcting section 12b provided on the second re-conveying passage RTb.

The image forming apparatus changes a conveyance route to convey a sheet in accordance with information of one side printing or double-side printing from the sheet conveying passage28 to the second re-conveying passage RTb. The second re-conveying passage RTb is used in the case where double-side printing is conducted, and is a passage to convey a sheet P having passed the second fixing device 9b again to the secondary transferring section 7A. The curl correcting section 12b corrects curl caused by a fixing process with the second fixing device 9b on the second re-conveying passage RTb. In this embodiment, there are not provided the first re-conveying passages RTa and RTa′.

Since other structures are the same as those in the fourth embodiment, description for the other structures is omitted.

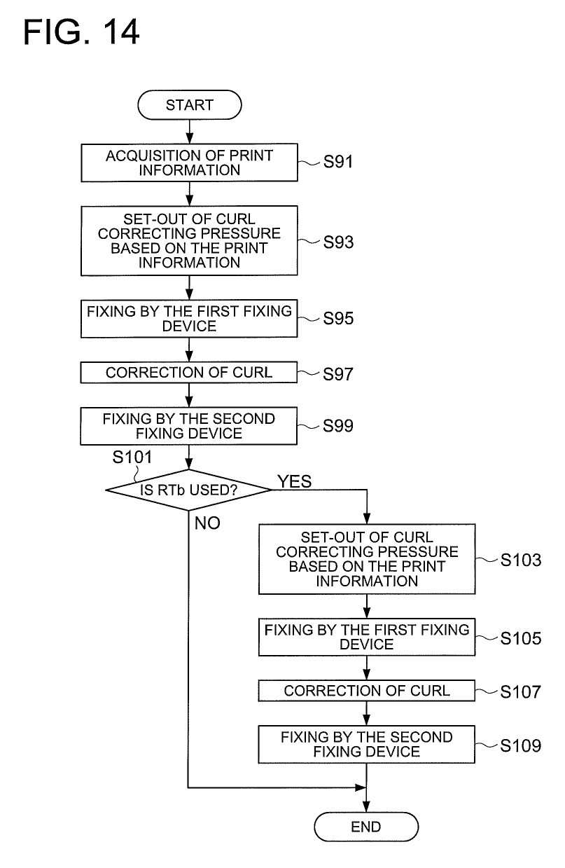

With reference to FIG. 14, an example of an operational procedure of the fixing unit shown in FIG. 13 will be explained.

(A) First, at Step S91, the pressure adjusting section 32 reads out the print information IF from the memory section 31. Then, the operational procedure proceeds to Step S93, the curl correcting section 11 sets up a pressure to be applied to a sheet P based on the print information IF. Subsequently, the operational procedure proceeds to Step S95, the first fixing device 9a conducts a fixing process to a sheet P on which a color toner image has been transferred in the second transfer process.

(B) The operational procedure proceeds to Step S97, the curl correcting section 11 conducts the first curl correcting process (first time) with the pressure set at Step S93 for the sheet P for which the fixing process has been conducted by the first fixing device 9a. Then, the operational procedure proceeds to Step S99, and the second fixing device 9b conducts a fixing process for the sheet for which the first curl correcting process has been conducted.

(C) The operational procedure proceeds to Step S101, in the case where a double-side printing is conducted and in the case where the sheet P which has passed through the second fixing device 9b is conveyed again to the secondary transferring section 7A (YES at Step S101), the sheet P is conveyed to the second re-conveying passage RTb, and a toner image is transferred onto the reverse side surface of the sheet P in the secondary transferring section 7A. Thereafter, the operational procedure proceeds to Step S103. On the other hand, in the case that the second re-conveying passage RTb is not used (NO at Step S101), that is, for the sheet P in which toner images have been formed only onto the obverse side surface, the flow chart shown in FIG. 14 is ended.

(D) For the sheet on the reverse side surface of which a toner image has been transferred through the conveyance route of the second re-conveying passage RTb, at Step S103, the curl correcting section 11 sets up a pressure to be applied onto the sheet P based on the print information IF. The operational procedure proceeds to Step S105, the first fixing device 9a conducts a fixing process for the sheet P onto which the color toner image has been transferred at the second transfer process. The operational procedure proceeds directly to Step S107, the curl correcting section 11 conducts the second curl correcting process (second time) with the pressure set up at Step S103 for the sheet P for which the fixing process has been conducted by the first fixing device 9a. Finally, at Step S109, the second fixing device 9b conducts a fixing process again to the sheet P for which the curl correcting process has been conducted.

Further, in the case that the second re-conveying passage RTb is used (YES at Step S101), a curl correcting section 12b may conduct a curl correcting process on the second re-conveying passage RTb for the sheet P for which the fixing process was conducted by the second fixing device 9b.

### Other Embodiments

As mentioned above, although the present invention has been explained based on five embodiments, it should not be understood that the descriptions and the drawings made a part of the disclosure do not limit the present invention. From this disclosure, various alternative embodiments, examples and application techniques are obvious for an ordinary person.

In the first through fifth embodiments, shown is an example that the fixing process is conducted two times with the two fixing devices 9a and 9b. However, the number of fixing devices and the number of times of fixing process may not be limited to two, and may be three or more. In this case, a curl correcting section may be provided between each pair of fixing devices among three or more fixing devices installed serially on the sheet conveying passage28.

With this arrangement, since these curl correcting sections correct curl generated by each fixing device respectively, it becomes possible to refrain wrinkles and jams of a sheet P which may occur at an entrance of a fixing device located at the downstream side than each curl correcting.

For example, an image forming apparatus may be equipped with a first fixing device 9a arranged on a sheet conveying passage 28, a second fixing device 9b arranged at the downstream side than the first fixing device 9c arranged at the downstream side than the second fixing device 9b on the sheet conveying passage28, a first curl correcting section 11 provided on the sheet conveying passage28 between the first fixing device 9a and the second fixing device 9b so as to correct curl on a sheet P by applying a pressure on the sheet P, and a second curl correcting section provided on the sheet conveying passage28 between the second fixing device 9b and the third fixing device 9c so as to correct curl on a sheet P by applying a pressure on the sheet P.

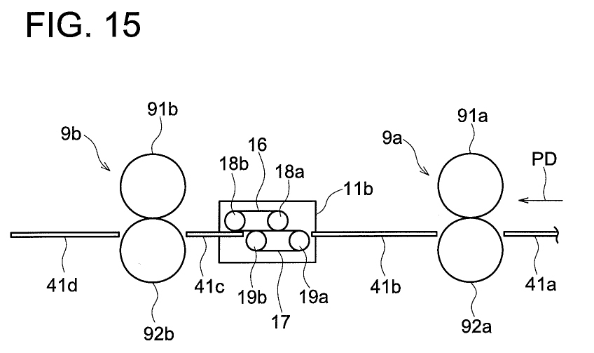

Moreover, FIG. 2 shows a curl correcting section 11 which is equipped with a pair of an upper side pressing roller 18 and a lower side pressing roller 19 and corrects curl by making the upper side pressing roller 18 and the lower side pressing roller 19 to apply a pressure onto a sheet P. However, the structure of the curl correcting section 11 is not limited to the above structure shown in FIG. 2. For example, as shown in FIG. 15, a curl correcting section 11b comprises an upper side belt 16a, two upper side pressing rollers 18a and 18b around which the upper side belt 16 is wound, a lower side belt 17 and two lower side pressing rollers 19a and 19b around which the lower side belt 17 is wound, and the curl correcting section 11b is adapted to sandwich a sheet P between the upper side belt 16 and the lower side belt 17 and corrects curl on the sheet P by applying a pressure onto the sheet P.

Thus, it should be understood that the present invention include various embodiments and the like which have not been described in this specification. Therefore, the present invention may be limited by only the invention specification matter related to appropriate claims from this disclosure.

What is claimed is:

1. An image forming apparatus for conducting a fixing process by plural fixing devices for a sheet on which a toner image has been transferred from a transfer section, comprising:
a first fixing device arranged on a sheet conveyance passage;
a second fixing device arranged on the sheet conveyance passage at a downstream side of the first fixing device; and
a curl correcting section arranged on the sheet conveyance passage between the first fixing device and the second fixing device.

2. The image forming apparatus described in claim 1, wherein a distance between the first fixing device and the second fixing device is equal to or less than a length, in a conveying direction, of a sheet having the maximum size capable of being handled by the image forming apparatus.

3. The image forming apparatus described in claim 1, further comprising:
a pressure regulating section to regulate a pressure to be applied onto a sheet by the curl correcting section based on an image forming condition.

4. The image forming apparatus described in claim 1, further comprising:
a first re-conveyance passage made to branch from the conveyance passage between the first fixing device and the curl correcting section such that a sheet is conveyed again from the conveyance passage along the first re-conveyance passage to the transfer section.

5. The image forming apparatus described in claim 1, further comprising:
a first re-conveyance passage made to branch from the conveyance passage between the curl correcting section and the second fixing device such that a sheet is conveyed again from the conveyance passage along the first re-conveyance passage to the transfer section.

6. The image forming apparatus described in claim 1, further comprising:
a second re-conveyance passage made to branch from the conveyance passage at a downstream side of the second fixing device such that a sheet is conveyed again from the conveyance passage along the second re-conveyance passage to the transfer section.

7. The image forming apparatus described in claim 1, further comprising:
a first re-conveyance passage made to branch from the conveyance passage between the curl correcting section and the second fixing device and a second re-conveyance passage made to branch from the conveyance passage at a downstream side of the second fixing device such that a sheet having a image on one side thereof is conveyed again from the conveyance passage to the transfer section, and
a control section to select one of the first re-conveyance passage and the second re-conveyance passage in accordance with an image forming condition.

8. The image forming apparatus described in claim 1, wherein when images are formed on both sides of a sheet, the control section controls the curl correcting section to conduct a first curl correction for the sheet having an image on an obverse side surface thereon and to conduct a second curl correction for the sheet on which an image is formed on a reverse side surface through one of the first re-conveyance passage and the second re-conveyance passage.

9. The image forming apparatus described in claim 1, wherein the control section makes a curl correcting pressure at the second curl correction to be lower than that at the first curl correction.
